(19) United States
(12) Patent Application Publication
(10) Pub. No.: US 2026/0115964 A1
(43) Pub. Date: Apr. 30, 2026

(54) FIRE-RETARDANT-TREATED WOOD COMPOSITE PANELS AND METHODS OF MANUFACTURE THEREOF

(71) Applicant: LOUISIANA-PACIFIC CORPORATION, NASHVILLE, TN (US)

(72) Inventors: JIANWEN NI, FRANKLIN, TN (US); SCOTT JOHNSON, PORTLAND, OR (US); JEFFREY YELLE, HENDERSONVILLE, TN (US); G. PAUL MERRICK, GIG HARBOR, WA (US); BRIAN ST. GERMAIN, MT. JULIET, TN (US); CHRISTOPHER DALL, NASHVILLE, TN (US)

(21) Appl. No.: 19/374,880

(22) Filed: Oct. 30, 2025

Related U.S. Application Data
(63) Continuation-in-part of application No. 17/747,930, filed on May 18, 2022.
(63) Continuation-in-part of application No. 18/109,036, filed on Feb. 13, 2023.
(63) Continuation-in-part of application No. 18/097,048, filed on Jan. 13, 2023.
(63) Continuation-in-part of application No. 18/218,476, filed on Jul. 5, 2023.
(60) Provisional application No. 63/189,725, filed on May 18, 2021.
(60) Provisional application No. 63/254,559, filed on Oct. 12, 2021.
(60) Provisional application No. 63/299,057, filed on Jan. 13, 2022.
(60) Provisional application No. 63/309,568, filed on Feb. 13, 2022.
(60) Provisional application No. 63/324,105, filed on Mar. 27, 2022.
(60) Provisional application No. 63/326,168, filed on Mar. 31, 2022.
(60) Provisional application No. 63/358,205, filed on Jul. 4, 2022.

(51) Int. Cl. B27N 9/00; B27N 1/00; B27N 3/02; E04C 2/10

(52) U.S. Cl. CPC B27N 9/00; B27N 1/00; B27N 3/02; E04C 2/10

(57) ABSTRACT

A process and method for producing a fire-retardant treated wood composite by applying fire-retardant material to wood strands at several points in the manufacturing process prior to the application of heat and/or pressure to a strand mat to form a manufactured wood or engineered wood composite panel. Fire-retardant material is applied at the dry bin outfeed, the blender infeed, or both. The fire-retardant material applied may be of a different type and/or different amount at each location. Optionally, fire retardant material also may be applied in the blender.

This application is a continuation-in-part application of U.S. patent application Ser. No. 17/747,930, filed May 18, 2022 (U.S. Pub. 2022/0372749), which claims benefit of and priority to U.S. Provisional Applications No. 63/189,725, filed May 18, 2021, and No. 63/254,559, filed Oct. 12, 2021; this application also is a continuation-in-part of U.S. patent application Ser. No. 18/109,036, filed Feb. 13, 2023, which claims benefit of and priority to U.S. Provisional Applications No. 63/309,568, filed Feb. 13, 2022, No. 63/324,105, filed Mar. 27, 2022, and No. 63/326,168, filed Mar. 31, 2022; this application also is a continuation-in-part application of U.S. patent application Ser. No. 18/097,048, filed Jan. 13, 2023 (U.S. Pub. 2023/0219327), which claims benefit of and priority to U.S. Provisional Application No. 63/299,057, filed Jan. 13, 2022; this application also is a continuation-in-part application of U.S. patent application Ser. No. 18/218,476, filed Jul. 5, 2023 (U.S. Pub. 2024/0001587), which claims benefit of and priority to U.S. Provisional Application No. 63/358,205, filed Jul. 4, 2022; all of the above references are incorporated herein in their entireties by specific reference for all purposes.

### FIELD OF INVENTION

This invention relates to a multi-layered, engineered-wood composite panel (which can be wood composite or wood-based panels, such as oriented strand board (OSB), plywood, or other cellulose-based panels) used for various applications such as, but not limited to, siding, trim, fencing, sheds, structural sheathing, or other sheathing, and various methods of production thereof.

### BACKGROUND OF THE INVENTION

Building wall and roof assemblies are commonly comprised of layers of several materials, each performing a specific function, that are installed separately, typically on the site where the building or structure is being constructed. Proper installation of the various layers individually and in combination creates challenges not only for the designer, but also for the installers. A typical assembly for residential home construction would include a dimension lumber frame, a sheathing layer, and a siding layer. In some cases, the sheathing and siding can be the same layer, such as a panel siding that is code approved as a sheathing. Wood-based composites, such as oriented strand board (OSB), have been found to be acceptable alternatives to veneer-based wood paneling (e.g. softwood plywood) and dimension wood products.

In general, wood-based composites include oriented strand board (OSB), wafer board, flake board, particle board as well as medium density fiberboard (MDF). These wood-based composites are typically formed from a wood material combined with a thermosetting adhesive to bind the wood substrate together. A significant advantage of strand and particle-based wood composites is that they have many of the properties of plywood and dimension lumber but can be made from a variety of lower grade wood species, smaller trees and waste from other wood product processing, and can be formed into panels in lengths and widths independent of size of the harvested timber.

One class of alternative products are multilayer oriented wood strand board products, particularly those with a targeted layer-to-layer oriented strand pattern, such as OSB. These oriented strand, multilayer composite wood panel products are composed of several layers of thin wood strands, which are wood particles having a length which is several times greater than their width. These strands are created from debarked round logs by placing the edge of a cutting knife parallel to a length of the log and then slicing thin strands from the log. The result is a strand in which the fiber elements are substantially parallel to the strand length. These strands can then be oriented on the mat-forming line with the strands of the face layers predominantly oriented in a parallel to machine direction orientation and strands in the core layer oriented, generally, perpendicular to the face layers (e.g., cross-machine) direction.

In one common commercial process these layers are bonded together using natural or synthetic adhesive resins under heat and pressure to make the finished product. Oriented, multilayer wood strand boards of the above-described type can be produced with mechanical and physical properties comparable to those of commercial softwood plywood and are used interchangeably, such as for wall and roof sheathing. In certain types of construction, these panels (and other construction materials) may be required by building codes to meet certain durability requirements, such as fire, wind and water resistance.

Oriented, multilayer wood strand boards of the above-described type, and examples of processes for pressing and production thereof, are described in detail in U.S. Pat. Nos. 3,164,511; 4,364,984; 5,425,976; 5,470,631; 5,525,394; 5,718,786; 6,461,743; and U.S. patent application Ser. No. 17/747,930; all of which are incorporated herein in their entireties by specific reference for all purposes.

Building wall and roof assemblies typically are constructed by attaching several panels of the above-described type as “sheathing” to an underlying supporting structure frame. These sheathing panels are often placed in a pattern forming a substantially continuous flat surface. In certain types of construction, the panels (and other construction materials) may be required under applicable building codes to meet certain fire resistance or water resistance requirements.

Engineered wood siding and trim are specialty grades of OSB that may be attached over sheathing or directly to the wall framing (i.e., in place of sheathing). These products have enhanced properties to perform under exposed, exterior weathering applications. Engineered wood siding or trim may also be used as for decking, fencing, or similar ancillary construction with appropriate modifications to the manufacturing process described above.

### BRIEF DESCRIPTION OF THE DRAWINGS

FIG. 1 shows a cross-sectional view of a panel with FR-treated strands and an overlay and underlay.

FIG. 2 shows a cross-sectional view of a panel with FR-treated strands.

FIG. 3 shows a cross-sectional view of a panel with a coating layer, an overlay and an underlay.

FIG. 4 shows a cross-sectional view of a panel with FR-treated strands, a coating layer, an overlay and an underlay.

FIG. 5 shows a diagram of a process for creating an FR-treated panel with low melting point FR material and standard temperature pressing.

FIG. 6 shows a diagram of a process for creating an FR-treated panel with low melting point FR material and low temperature pressing.

FIG. 7 shows a diagram of a process for creating an FR-treated panel with overlays with low melting point FR material and standard temperature pressing.

FIG. 8 shows a diagram of a process for creating an FR-treated panel where FR material is added to the strands in the dry bin outfeed and the blender infeed, prior to blending the strands with other chemicals and adhesives.

FIG. 9 shows a diagram of a process for creating an FR-treated panel where FR material is added to the strands in the dry bin outfeed and the blender infeed, along with the option of adding FR material to the blender while blending the strands with other chemicals and adhesives.

FIG. 10 shows a diagram of a process for creating an FR-treated panel with high melting point FR material and standard temperature pressing.

### DETAILED DESCRIPTION OF EXEMPLARY EMBODIMENTS

In various exemplary embodiments, the present invention comprises a multi-layer fire-resistant (FR) panel or board 2 for use in applications such as, but not limited to, siding, trim, fencing, sheds, structural sheathing, or other sheathing. The multi-layer panel or board 2 comprises a base engineered-wood panel layer 10, such as OSB. This base panel layer may be multilayered, such as multiple layers of oriented strands 12. An optional fines layer 14 may be placed thereon.

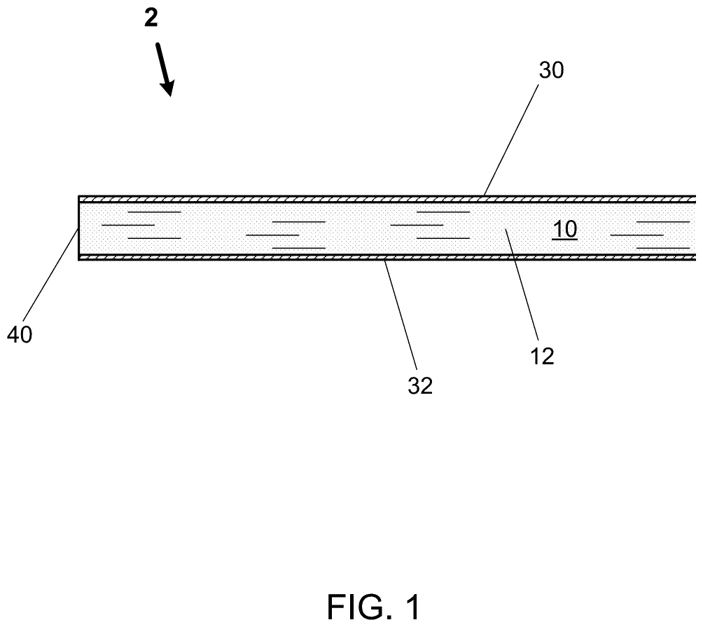

FIGS. 1-4 shows examples of FR panels in accordance with the present invention for use as structural sheathing or siding panels. The multi-layer panel comprises a wood structural panel 10, such as OSB, treated or coated with a product that provides fire resistance. The FR treatment may be integrated 12 with the strand or other cellulosic material forming the wood structural panel (as seen in FIGS. 1, 2 and 4). The FR treatment 12 thus is integrated with the material forming the wood structural panel 2 (e.g., blended with the flakes making up the mats for production of the OSB). The treatment may be blended with the material used for just one or more certain layers (e.g., top, bottom, core), or with the materials used for all of the layers. In some embodiments, the FR treatment 12 is dispersed through the wood substrate, but may be found at higher concentrations in certain layers, or certain areas of a mat, or certain locations within the wood substrate as a whole. In additional embodiments, the FR treatment may be dispersed or spread more uniformly through a mat or the wood substrate as a whole.

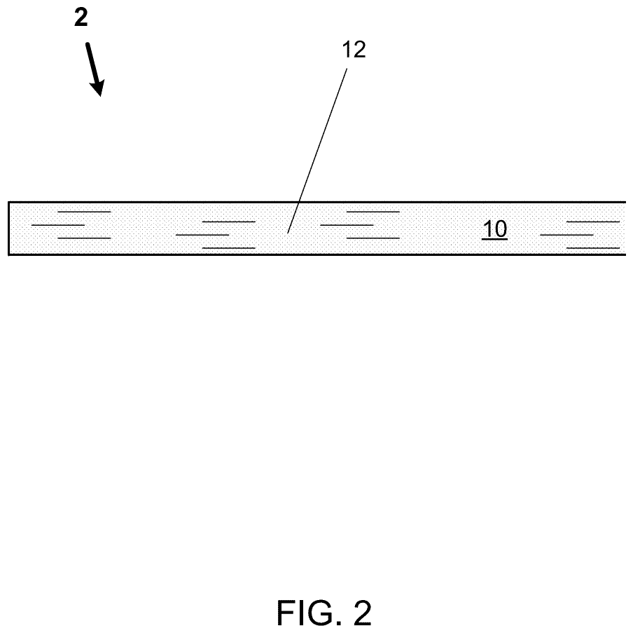

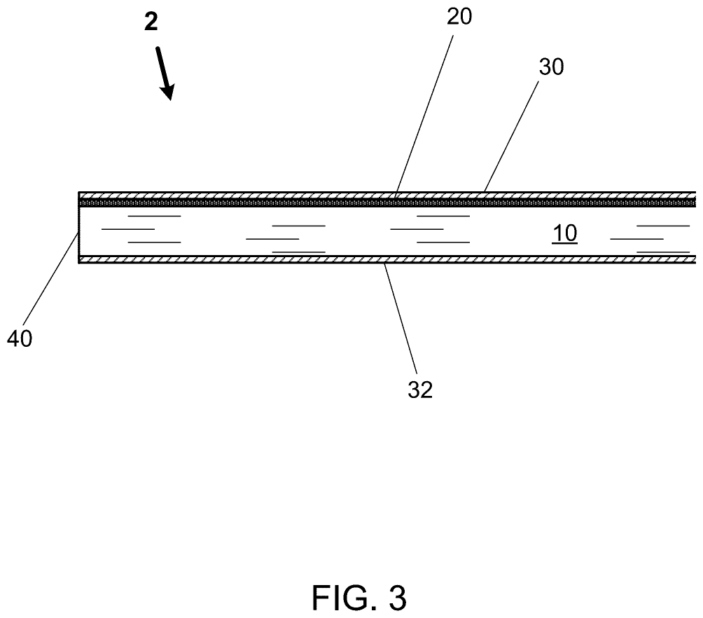

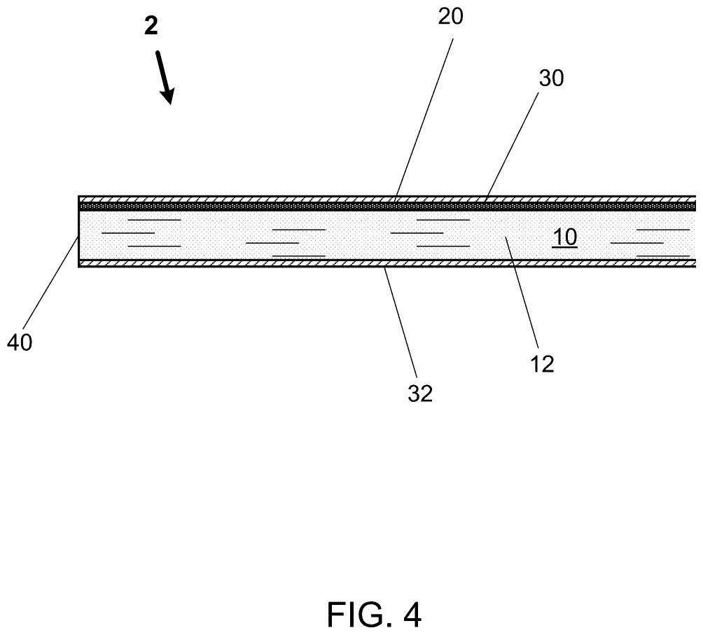

Alternatively, the FR treatment may be a coating layer 20 applied to the mat or mat layer after being formed (as seen in FIG. 2). In another embodiment, FR treatment may be both integrated 12 and applied as a coating layer 20, using the same or different FR substances or materials, as seen in FIG. 3. FIG. 4 shows an embodiment of a panel with integrated FR treatment but without a coating or overlay. In various embodiments, the treatment gives the panel fire resistant characteristics, which may be for use in fire-resistance-rated assemblies, or where FR treated wood is required by building codes, as described above.

In the embodiments shown, at least one sheet of a weather-resistant overlay, e.g., a resin-impregnated paper overlay 30, may be placed as a protective layer on the top of the mat before the mat and overlay are pressed to form a FRT composite panel of the present invention. At least one sheet of overlay may also be placed underneath 32 the strand mat being formed, and in some embodiments, sheets of overlay are located both underneath and over the mat, thereby providing an overlay (protective layer) on both faces of the FR composite panel.

In several embodiments, the present invention applies a borate, borax, or boric acid (i.e., orthoboric acid or boracic acid, B(OH)₃) dispersion to the wood strands prior to formation of a mat layer or a mat, and thus prior to application of heat and pressure in the press to form the composite panel. In some embodiments, the borate used is sodium borate, zinc borate or calcium borate. Calcium borate has a melting point of 986 degrees C., and zinc borate has a melting point of 1150 degrees C., while the press temperature during manufacture of the panel remains typically below, often well below, 900 degrees C. The zinc borate and/or calcium borate are not melted during the pressing, thereby generally avoiding possible press FR material build-up issues.

In further exemplary embodiments, after pressing the panel may then be primed and/or coated with a water-resistant coating. Edge sealant may be applied to the edges 40, 140 of the panels. In an alternative embodiment, a weather-resistant or protective sheet or layer may be applied to the FR panel in a secondary manufacturing process.

The overlay protective layer or layers, with or without their own FR treatment, as described above, help prevent or reduce FR chemical loss by limiting or preventing the core and any other FR treated layer(s) (in the mat or on the surface of the mat) from being exposed to water and/or weather, and by keeping or limiting the FR chemicals from leaching out of the panel.

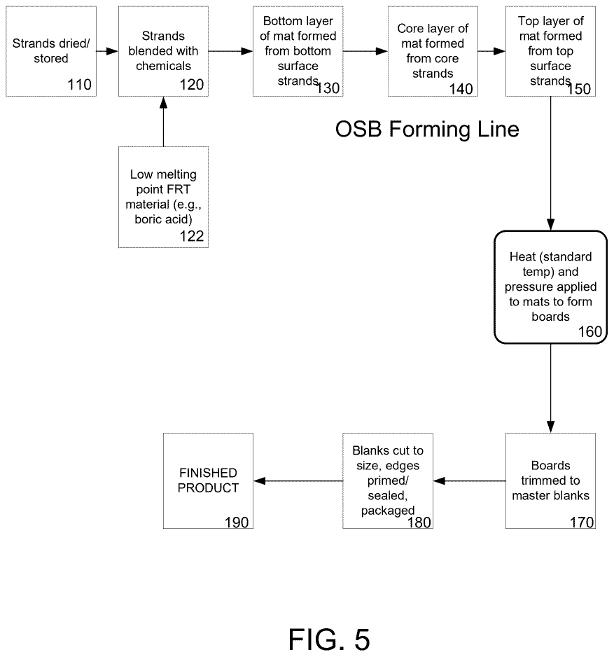

Steps of a manufacturing process in accordance with the present invention using a press are shown in FIG. 5. These steps include the drying and storing of wood strands 110, the treatment or blending of designated strands (e.g., bottom, core, top, or all strands) with applicable chemicals and/or additives (e.g., wax, resin, and the like) 120, including FR treatment (possibly with lower melting points) 122 being added to the blending apparatus, the forming of the appropriate layers in order (first bottom surface, then core, then top surface) using designated strands, 130, 140, 150, the application of low press heat and pressure to the mats using a primary press to form boards 160, and subsequent trimming 170 and processing (e.g., panels cut to size, edges primed/sealed, and packaging) 180 to produce the finished product 190. Strands for a particular layer typically are blended with applicable chemicals and/or additives in a bin or blender, separate from strands for other layers, although this is not always the case. Additionally, as described above, in some embodiments the treatment 12 is dispersed through the wood substrate, but may be found at higher concentrations in certain layers, or certain areas of a mat, or certain locations within the wood substrate as a whole. In some embodiments, the treatment may be dispersed or spread more uniformly through a mat or the wood substrate as a whole.

In some embodiments of the manufacturing process where lower melting point borate products, such as boric acid, are used in combination with a higher (up to the typical or standard) press temperature, one or more sheets of overlay paper may be placed on the bottom and/or top of the mat before the mat and paper overlay are pressed to form a FRT composite panel of the present invention. This arrangement keeps the low melting point material from building up in or on the press platens. The paper overlay may comprise a resin-impregnated overlay. In addition to the overlay, or as substitute therefor, a release agent may be applied to the top surface of the mat, and to the bottom screen or plate, prior to entering the press. The use of the release agent will allow raising the press temperature to a point slightly above the melting/softening temperature of the fire retardant, while preventing sticking. For example, with the release agent, when a boric-acid-based fire retardant is used, the press temperature can be set at 175° C., slightly above the melting point of boric acid.

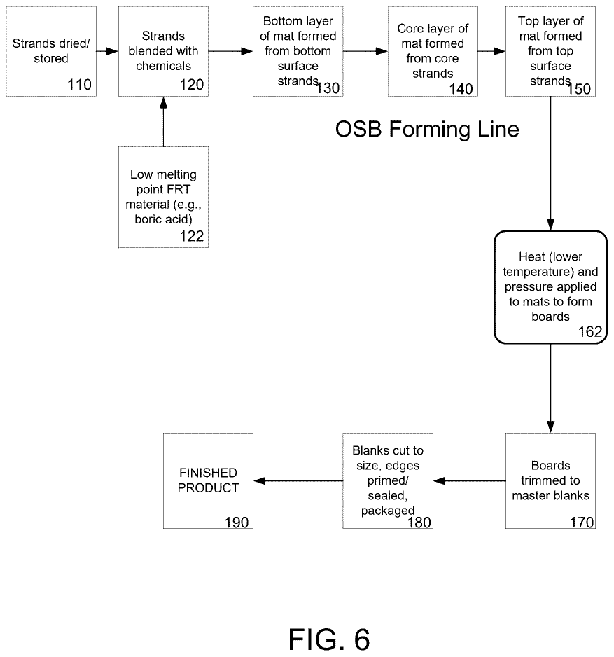

Steps of another manufacturing process in accordance with the present invention using a low temperature press are shown in FIG. 6. These steps include the drying and storing of wood strands 110, the treatment or blending of designated strands (e.g., bottom, core, top, or all strands) with applicable chemicals and/or additives (e.g., wax, resin, and the like) 120, including FR treatment 122 being added to the blending apparatus, the forming of the appropriate layers in order (first bottom surface, then core, then top surface) using designated strands, 130, 140, 150, the application of a lower press heat and pressure to the mats using a primary press to form boards 162, and subsequent trimming 170 and processing (e.g., panels cut to size, edges primed/sealed, and packaging) 180 to produce the finished product 190. As described elsewhere herein, in this method the press temperature is reduced to a temperature below the melting point of the FR (e.g., boric acid), which is well below the standard (higher) press temperature for manufactured wood substrates such as OSB. In certain embodiments, the temperature is reduced to approximately 168° C., or to a range of approximately 140° C. to 170° C., more preferably 165° C. to 168° C.

Strands for a particular layer typically are blended with applicable chemicals and/or additives in a bin or blender, separate from strands for other layers, although this is not always the case. Additionally, as described above, in some embodiments the treatment 12 is dispersed through the wood substrate, but may be found at higher concentrations in certain layers, or certain areas of a mat, or certain locations within the wood substrate as a whole. In some embodiments, the treatment may be dispersed or spread more uniformly through a mat or the wood substrate as a whole.

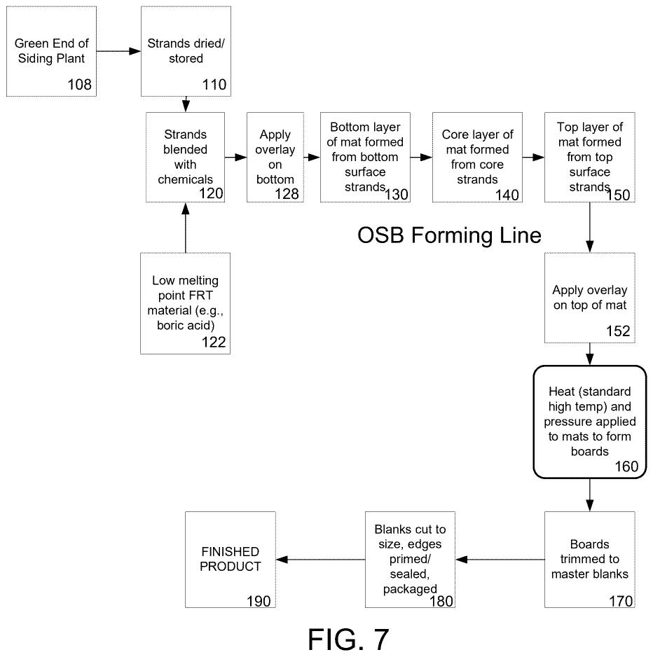

FIG. 7 shows a variation of the process of FIG. 5, where an overlay layer, as described elsewhere herein, may be placed on the forming line first to act as an “underlay,” 128 with the various mat layers formed thereon. An overlay may be applied to the top of the mat 152. While FIG. 7 shows both an underlay layer and an overlay layer being applied, in several embodiments, just the underlay layer or the overlay layer may be applied.

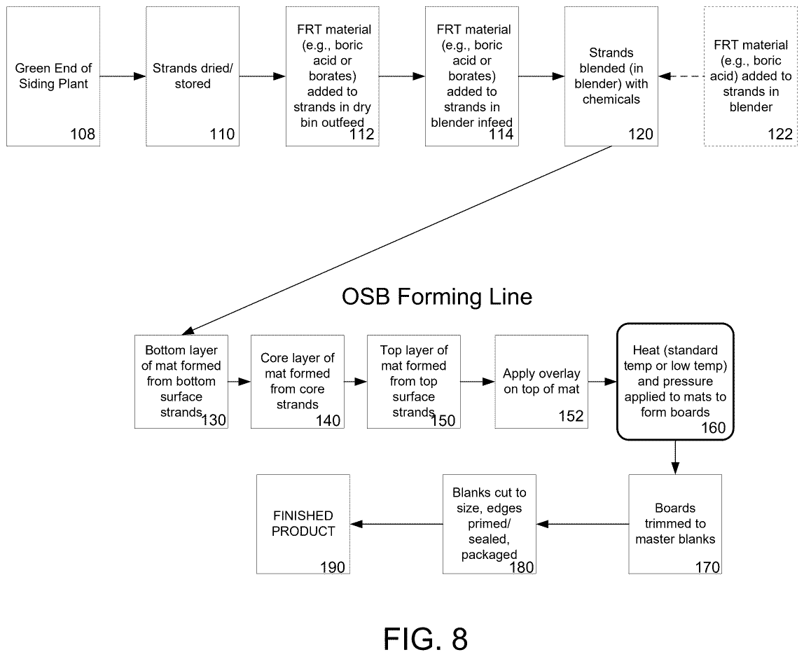

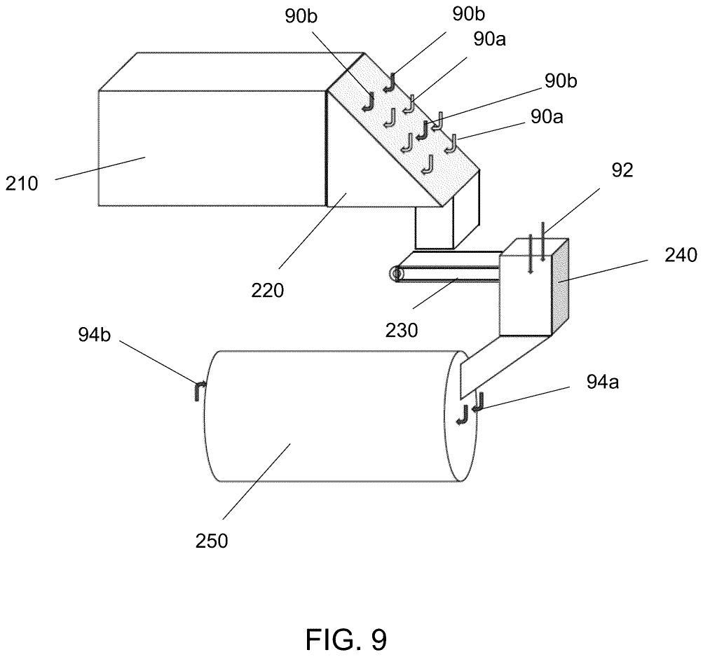

A large dosage of FR, e.g., approximately 5% to 25%, preferably 10% to 20%, more preferably 12% to 18%, most preferably 15% to 18%, based on the weight of wood, is typically necessary to meet the code requirements for wood structural panels. To effectively distribute the FR to individual strands, FR may be added in various stages of the process, as shown in FIGS. 8 and 9.

FIG. 8 shows the steps of a manufacturing process in accordance with the present invention for adding FR at various pre-press stages. These steps include the production of strands at the “green end” of the plant 108, drying and storing of wood strands 110, conveying the strands through a dry bin infeed to a designated (e.g., bottom surface strands, top surface strands, both surface strands, core strands, or all strands) dry bin 210, treating the designated strands with FR material as the strands leave the designated dry bin through the corresponding dry bin outfeed 112, 220, conveying the treated strands on a weigh belt 230 to a blender infeed (e.g., drop chute 240), treating the designated strands with FR material while passing through the blender infeed 114 to the blender 250, blending of designated strands with applicable chemicals and/or additives (e.g., wax, resin, and the like) 120, which may include the application of FR treatment 122 being added to the blender 250, the forming of the appropriate layers in order (first the bottom surface layer 130, then the core layer 140, then top surface layer 150) using corresponding designated strands, the application of appropriate press heat and pressure to the mats using a primary press to form boards 160, and subsequent trimming 170 and processing (e.g., panels cut to size, edges primed/sealed, and packaging) 180 to produce the finished product 190.

FIG. 9 shows FR material being adding to the strands by spray nozzles or atomizers (such as, but not limited to, a spinning disk atomizer) 90a in the dry bin outfeed 220, and FR material (which may or may not be the same as the previous FR material) through spray nozzles or atomizers 92 in the blender infeed 240, which helps ensure that the strands are adequately coated and have the opportunity to absorb the FR treatment material before the strands are mixed with resin, wax, and other chemicals in the blender, which can interfere with the coating and absorption of FR treatment by the strands if the FR treatment is added directly to the blender with the resin, wax, adhesives, and chemicals, or at points after blending. The addition of FR treatment material prior to blending also will reduce the amount of build-up inside the blender. The blender infeed nozzles 92 may be directed downward so as to avoid spraying FR material on or otherwise contacting the weigh belt, as the accumulation or buildup of FR material on the weigh belt may cause problem with the weigh belt operations, including the accurate weighing of the treated strands as they are conveyed thereon.

FIG. 9 shows a third set of nozzles/atomizers 94a,b that may be used to apply FR material (which may or may not be the same as the FR material already applied to the strands) to the strands in the interior of the blender. These nozzles/atomizers may be located at the intake end 94a of the blender or the outfeed end 94b of the blender. While FIG. 9 shows two intake end nozzles and a single outfeed end nozzle, these relative numbers may be reversed, or any number of nozzles may be provided.

The dry bin outfeed nozzles 90a may be arranged so as to provide complete coverage and dispersal of the FR material onto the strands as they pass through the dry bin outfeed 220. In several embodiments, additional nozzles/atomizers 90b may be added, such as when no FR material is being added through blender nozzles/atomizers 94a, 94b, or when the latter are being used for other materials or additives, or are removed or otherwise not present. In the embodiment shown, the majority of the FR treatment material is added at the dry bin outfeed in either case.

While FIGS. 8 and 9 show the addition of FR in the dry bin outfeed (i.e., the conveyance of strands from the dry bin) and the blender infeed (i.e., the conveyance of strands to the blender), the addition of FR may also occur at other points prior to blending, such as the wet bin outfeed or the dry bin infeed, or after blending.

An alternative approach would be to install a separate set of blenders with the specific and sole purpose of adding the FR treatment to the strands, and then these FR treated strands are subsequently processed through the normal blender and blending processes to add the resin/wax/etc. needed for OSB production. This alternative approach would allow for specific modifications to blending variables (i.e., speed, angle, RPM, spray nozzles, and the like) to ensure a more complete application and absorption of the FR treatment. This approach would also further reduce blender build-up in the blenders themselves, and reduce the potential interference of the FR treatment with proper resin/wax blending, and vice-versa.

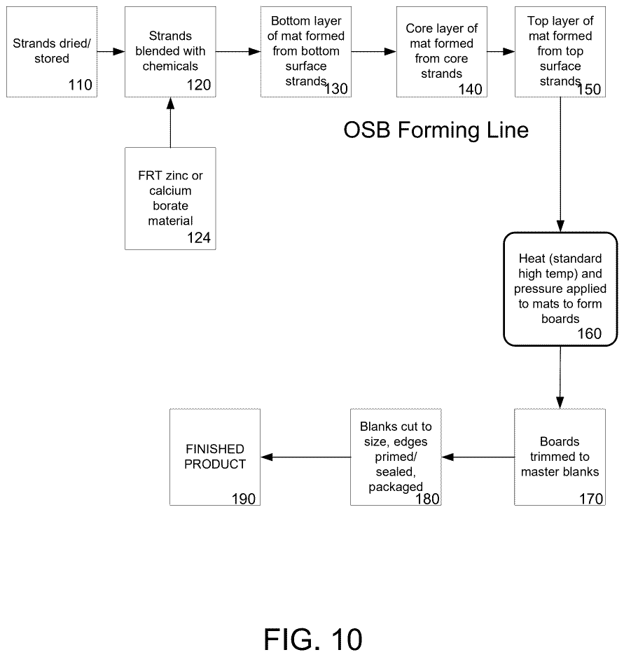

FIG. 10 shows an embodiment of the manufacturing process where higher melting point borate products, such as zinc borate or calcium borates, are used as the FR treatment 124 that is blended with the wood strands 120. In this embodiment, standard (i.e., higher) temperature heat and/or pressure is applied to the mats to form the boards 160.

In the embodiments shown, at least one sheet of a weather-resistant overlay, e.g., a resin-impregnated paper overlay 30, may be placed as a protective layer on the top of the mat before the mat and overlay are pressed to form a FRT composite panel of the present invention. At least one sheet of overlay 32 may also be placed underneath the mat being formed, and in some embodiments, sheets of overlay are located both underneath and over the mat, thereby providing an overlay (protective layer) on both faces of the FR composite panel.

After pressing, the FR panel may then be primed and/or coated with a water-resistant coating. Edge sealant may be applied to the edges 40 of the panels. In an alternative embodiment, a weather-resistant or protective sheet or layer may be applied to the FR panel in a secondary manufacturing process.

The overlay protective layer(s), as described above, helps prevent or reduce FRT chemical loss by limiting or preventing the core and other FR treated layer(s) (in the mat or on the surface of the mat) from being exposed to water and/or weather, and by keeping or limiting FRT chemicals from leaching out of the panel.

Thus, in some embodiments the laminate is not placed on the mat prior to the initial or primary pressing. Instead, the laminate may be applied to an engineered wood composite panel, which has already undergone primary pressing, in a secondary laminating process. The secondary laminating process may occur prior to or after the final machining of the initial panel into the desired siding, trim, fence, or sheathing component. In this embodiment, the laminate may be, but need not be, a dry, sheet-like product. The laminate may instead comprise a viscous liquid or semi-solid film that is applied, which then solidifies and bonds to the underlying substrate using suitable and compatible processing (e.g., UV light). Another feature of this embodiment is that the laminate may replace, or be used without the need for, a fines layer. A further feature of this embodiment is that the laminate may be formed (i.e., wrapped) around the edges of the product.

A further advantage of the application of applying FR treatment to the strands prior to pressing is that panels as described herein are often cut or sawn at the job site to fit the needs of certain elements under construction, and the cut becomes an exposed edge which will not have been affected by prior surface and/or edge treatments applied to the panel. By treating the strands with FR materials as described herein, the newly exposed edge will effectively already have been treated upon exposure due to the treatment applied to the strands during formation.

Applying borate additives as described above, including, but not limited to, high or elevated levels of calcium borate and/or zinc borate additives, to composite or manufactured wood panels, such as OSB, also provides improved surface antifungal and anti-termite properties. More particularly, application of a borate, such as, but not limited to, zinc borate to one or more layers of a manufactured wood panel (e.g., OSB) at approximately 2.0% (m/m) or higher, more preferably above 2.0% (m/m) to approximately 2.5% (m/m), which produces the surprising result of resisting surface fungal growth. In particular, OSB panels generated from Aspen and Southern Yellow Pine (SYP) wood species are successfully treated with zinc borate levels of at least approximately 2.0% (m/m), and found to resist surface fungal growth when tested against five different microorganisms by the ASTM G21-15 “Standard Practice for Determining Resistance of Synthetic Polymeric Materials to Fungi” method (reapproved 2021, and as may be updated thereafter). Test results and/or the prior art indicate that lower levels of zinc borate (e.g., below about 1.0 m/m) are not as effective at resisting surface mold growth.

In various embodiments of the present invention, a borate dispersion thus may be added to the wood strands making up one or more layers of the OSB panel. Alternatively, the borate dispersion may may be added at a particular level to just the wood strands making up the top surface layer, with the borate dispersion in the core or bottom surface layer added at a different level or levels. A different amount can be added to the wood strands making up the core layer or layers separately from the amount added to the wood strands making up the surface layer or layers. In an alternative embodiment, a base level of borate dispersion may be added to all of the wood strands, and then additional and/or a different form or borate dispersion may be added to the wood strands making up the top and/or bottom surface layer or layers.

In several of the above embodiments, the FR laminate provides both burn-through resistance and flame-spread resistance. The FR laminate applied to the surface of an FRT panel (e.g., an FRT base OSB panel), as described above, thus provides burn-through resistance (and its own flame-spread resistance) in addition to the flame-spread resistance provided by the underlying FRT panel, thereby enhancing overall performance in a fire event, internal or external. This is in addition to the FR laminate helping to reduce FRT chemical treatments from leaching from the underlying FRT panel.

Examples of a FR laminate that may be used in the present invention include, but are not limited to, one or more of the following: woven or nonwoven fiberglass veils; woven or nonwoven FR fabrics; or combinations thereof. These FR laminates allow the resulting engineered wood panels, which can be used individually, to also be used in approved fire-rated assemblies, or where FRT protection is needed and or required by building codes, as discussed above.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A method for producing a fire-retardant treated wood composite panel, comprising the steps of:
obtaining a plurality of wood strands;
conveying the plurality of wood strands to a dry bin;
conveying the plurality of wood strands from the dry bin through a dry bin outfeed;
applying a first fire-retardant to the plurality of wood strands as they pass through the dry bin outfeed;
conveying the plurality of treated wood strands through a blender infeed;
conveying the plurality of treated wood strands into a blender;
mixing, in the blender, the treated wood strands with one or more resins, waxes or adhesives;
after mixing in a blender, forming one or more layers of a strand mat with said fire-retardant treated wood strands on a forming line;
applying pressure and/or heat by a press at a press temperature to the strand mat to form a fire-retardant treated wood composite board; and
processing the wood composite board to form one or more fire-retardant treated composite wood panels.

2. The method of claim 1, further comprising the step of applying a second fire-retardant to the plurality of treated wood strands as they pass through the blender infeed.

3. The method of claim 2, further comprising the step of applying a third fire-retardant to the treated wood strands as they are mixed in the blender.

4. The method of claim 2, wherein the first fire-retardant and the second fire-retardant are the same.

5. The method of claim 2, wherein the amount of first fire-retardant applied is different from the amount of second fire-retardant applied.

6. The method of claim 2, wherein the first fire-retardant, the second fire-retardant, or both, comprise boric acid.

7. The method of claim 2, wherein the first fire-retardant, the second fire-retardant, or both, comprise zinc borate.

8. The method of claim 1, wherein the first fire-retardant, the second fire-retardant, or both, comprise calcium borate.

9. The method of claim 2, wherein the first fire-retardant and the second fire-retardant comprise boric acid and the press temperature is equal to or no more than approximately 168° C.

10. The method of claim 1, wherein the press temperature is approximately 168° C.

11. The method of claim 1, wherein the press temperature is approximately 150° C. to approximately 170° C.

12. The method of claim 1, wherein the press temperature is equal to or no more than approximately 220° C.

13. The method of claim 1, wherein the first fire-retardant is applied in an amount of approximately 5% to approximately 25% of the weight of the wood strands.

14. The method of claim 1, wherein the first fire-retardant is applied in an amount of approximately 15% to approximately 20% of the weight of the wood strands.

15. The method of claim 2, wherein the first fire-retardant and the second fire-retardant are applied in a total amount of approximately 10% to approximately 20% of the weight of the wood strands.

16. The method of claim 2, wherein the first fire-retardant and the second fire-retardant are applied in a total amount of approximately 15% to approximately 20% of the weight of the wood strands.

17. The method of claim 1, wherein the strand mat comprises two or more layers, and at least one of the two or more layers is treated with a different amount of first fire-retardant than the other layers.

18. A method for producing a fire-retardant treated wood composite panel, comprising the steps of:
obtaining a plurality of wood strands;
conveying the plurality of wood strands to a dry bin;
conveying the plurality of wood strands from the dry bin through a dry bin outfeed;
conveying the plurality of treated wood strands through a blender infeed;
applying a first fire-retardant to the plurality of treated wood strands as they pass through the blender infeed;
conveying the plurality of treated wood strands into a blender;
mixing, in the blender, the treated wood strands with one or more resins, waxes or adhesives;
after mixing in a blender, forming one or more layers of a strand mat with said fire-retardant treated wood strands on a forming line;
applying pressure and/or heat by a press at a press temperature to the strand mat to form a fire-retardant treated wood composite board; and
processing the wood composite board to form one or more fire-retardant treated composite wood panels.

19. The method of claim 1, further comprising the step of applying a second fire-retardant to the plurality of wood strands as they pass through the dry bin outfeed.

20. The method of claim 2, further comprising the step of applying a third fire-retardant to the treated wood strands as they are mixed in the blender.
